(19) United States
(12) Patent Application Publication
(10) Pub. No.: US 2007/0185303 A1
(43) Pub. Date: Aug. 9, 2007

(54) Compounds for organic electronic devices

(75) Inventors: Philipp Stossel, Frankfurt/Main (DE); Horst Vestweber, Gilersber-Winterscheid (DE); Holger Heil, Darmstadt (DE); Esther Breuning, Niedernhausen (DE)

Correspondence Address: CONNOLLY BOVE LODGE & HUTZ, LLP, P O BOX 2207, WILMINGTON, DE, 19899, US

(73) Assignee: Merck Patent GmbH Patents & Scientific Information, Damstadt (DE)

(21) Appl. No.: 11/630,493

(22) PCT Filed: Jun. 22, 2005
(86) PCT No.: PCT/EP05/06729

§ 371 Date: Dec. 22, 2006

(30) Foreign Application Priority Data
Jun. 26, 2004 (DE) 10 2004 031 000.9
Dec. 1, 2004 (EP) 04 028 407.7
Jan. 31, 2005 (EP) 05 001 891.0
May 3, 2005 (EP) 05 009 644.5

(51) Int. Cl. C08G 61/02

(52) U.S. Cl. 528/86

(57) ABSTRACT

The present invention relates to the improvement of organic electroluminescent devices, in particular blue-emitting devices, by using compounds of the formula (1) as dopants in the emitting layer.

The present invention describes novel compounds and the use thereof in organic electroluminescent devices.

The use of semiconducting organic compounds which are capable of the emission of light in the visible spectral region in organic electroluminescent devices (OLEDs) is just at the beginning of the market introduction. The general structure of such devices is described, for example, in U.S. Pat. No. 4,539,507, U.S. Pat. No. 5,151,629, EP 0676461 and WO 98/27136. For simple devices containing OLEDs, the market introduction has already taken place, as confirmed by the car radios from Pioneer, the mobile telephones from Pioneer and SNMD or a digital camera from Kodak with an “organic display”. Further products of this type are just about to be introduced.

However, these devices still exhibit considerable problems which require urgent improvement:

1. The efficiency is still too low, especially in the case of fluorescent OLEDs, and must be improved.

2. The operating lifetime is still short, in particular in the case of blue emission, meaning that it has to date only been possible to achieve simple applications commercially.

3. Stilbenamines, which are used in accordance with the prior art as blue-emitting dopants, generally exhibit only pale-blue, but not dark-blue emission. However, dark-blue emission is required, in particular, for the production of large-format full-colour displays.

4. Many blue-emitting emitters which comprise both aromatic amines and also double-bond systems are thermally unstable and decompose during sublimation or during vapour-deposition. The use of these systems is consequently impossible or only possible with considerable losses and with high technical complexity.

As closest prior art, mention may be made of the use of certain arylvinylamines by Idemitsu (for example WO 04/013073, WO 04/016575, WO 04/018587). Very good lifetimes in the case of dark-blue emission are thus quoted. However, these results, as can be seen, are highly dependent on the host material used, meaning that the quoted lifetimes cannot be compared as absolute values, but always only on use in an optimised system. Furthermore, these compounds are thermally unstable and cannot be evaporated without decomposition, which requires high technical complexity for the vapour deposition and thus represents a significant industrial disadvantage. A further disadvantage is the emission colour of these compounds. While Idemitsu quotes dark-blue emission (CIE y coordinates in the range 0.15-0.18), it has not been possible to reproduce these colour coordinates in simple devices in accordance with the prior art. On the contrary, green-blue emission is obtained here. It is not evident how blue emission can actually be produced using these compounds.

Thus, there continues to be a demand for blue-emitting compounds which result in good efficiencies and at the same time in long lifetimes in organic electroluminescent devices and which are straightforward to process industrially.

Surprisingly, it has now been found that organic electroluminescent devices which comprise certain compounds—indicated below—as blue-emitting dopants, preferably in a host material, have significant improvements over the prior art. Using these materials, it is possible to obtain longer lifetimes at the same time as higher efficiency. In addition, these compounds, in contrast to materials in accordance with the prior art, can be sublimed and vapour-deposited without significant decomposition and are therefore significantly easier to handle than materials in accordance with the prior art. The present invention therefore relates to these compounds and to the use thereof in OLEDs.

The invention relates to the use of compounds of the formula (1) 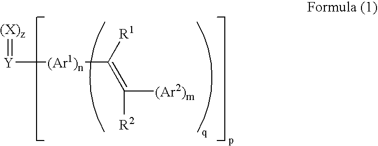
where the following applies to the symbols and indices used:
Y is on each occurrence phosphorus, arsenic, antimony, bismuth, oxygen, sulfur, selenium or tellurium, where, in the case of Y=oxygen, the radical X stands for a free electron pair and where, in the case of Y=sulfur, selenium or tellurium, the radical X, identically or differently on each occurrence, stands for a free electron pair or for oxygen;
X is on each occurrence, identically or differently, oxygen, sulfur, selenium, tellurium or stands for a free electron pair;
Ar¹ is on each occurrence, identically or differently, an aryl group having 6 to 24 C atoms or a heteroaryl group having 2 to 24 C atoms, which may be substituted by one or more radicals R¹⁰;
Ar² is on each occurrence, identically or differently, an aryl group having 6 to 24 C atoms or a heteroaryl group having 2 to 24 C atoms, which may be substituted by one or more radicals R¹⁰;
R¹, R² are on each occurrence, identically or differently, H, CN, F, a straight-chain alkyl group having 1 to 40 C atoms, a branched alkyl group having 3 to 40 C atoms, a cyclic alkyl group having 3 to 40 C atoms, where the above-mentioned alkyl groups may be substituted by one or more radicals R²⁰ and one or more non-adjacent CH₂ groups in the radical R¹ and/or R² may, independently of one another, be replaced by —R²⁰C═CR²⁰—, —C≡C—, Si(R²⁰)₂ Ge(R²⁰)₂, Sn(R²⁰)₂, C═O, C═S, C═Se, C═NR²⁰, —O—, —S—, —COOR²⁰— or —CONR²⁰— and where one or more H atoms may be replaced by F, Cl, Br, I, CN, SCN or NO₂,
   or an aromatic system having 6 to 40 aromatic C atoms or a heteroaromatic system having 2 to 40 aromatic C atoms, each of which may be substituted by one or more radicals R¹⁰,
   or an aryloxy group having 6 to 40 aromatic C atoms or a heteroaryloxy group having 2 to 40 aromatic C atoms, each of which may be substituted by one or more radicals R¹⁰, or
   R¹, R² may each, independently of one another, form a cyclic system together with the radical Ar¹ and/or Ar²;
R¹⁰ is on each occurrence, identically or differently, H, F, Cl, Br, I, CN, NO₂, a straight-chain alkyl group having 1 to 40 C atoms, a branched alkyl group having 3 to 40 C atoms, a cyclic alkyl group having 3 to 40 C atoms, where the above-mentioned alkyl groups may be substituted by one or more radicals R²⁰ and one or more non-adjacent CH₂ groups in the radical R¹⁰ may, independently of one another, be replaced by —R²⁰C═CR²⁰—, —C≡C—, Si(R²⁰)₂, Ge(R²⁰)₂, Sn(R²⁰)₂, C═O, C═S, C═Se, C═NR²⁰, —O—, —S—, —COOR²⁰— or —CONR²⁰— and where one or more H atoms may be replaced by F, Cl, Br, I, CN or NO₂, or an aryl group having 6 to 24 C atoms or a heteroaryl group having 2 to 24 C atoms, each of which may be substituted by one or more radicals R²⁰,
   or an aryloxy group having 6 to 24 aromatic C atoms or a heteroaryloxy group having 2 to 24 aromatic C atoms, each of which may be substituted by one or more radicals R²⁰,
   or a combination of two, three, four or five of these systems; two or more substituents R¹⁰ here, both on the same ring and also on different rings, may also form a mono- or polycyclic, aliphatic or aromatic ring system with one another or a ring system together with a radical R¹ and/or R²;
R²⁰ is on each occurrence, identically or differently, H or an aliphatic or aromatic hydrocarbon radical having 1 to 20 C atoms;
n is identical or different on each occurrence and stands for an integer 0, 1, 2, 3, 4 or 5;
m is identical or different on each occurrence and stands for an integer 0, 1, 2, 3, 4 or 5;
q is identical or different on each occurrence and stands for an integer 0, 1, 2, 3, 4 or 5, with the proviso that at least one index q is ≠0 zero;
p stands for the integer 2 in the case where the radical Y stands for an element from main group 6 of the Periodic Table and stands for the integer 3 in the case where the radical Y stands for an element from main group 5 of the Periodic Table;
z stands for the integer 1 in the case where Y stands for an element from main group 5 of the Periodic Table and stands for the integer 2 in the case where Y stands for an element from main group 6 of the Periodic Table;
   with the exception of the compounds 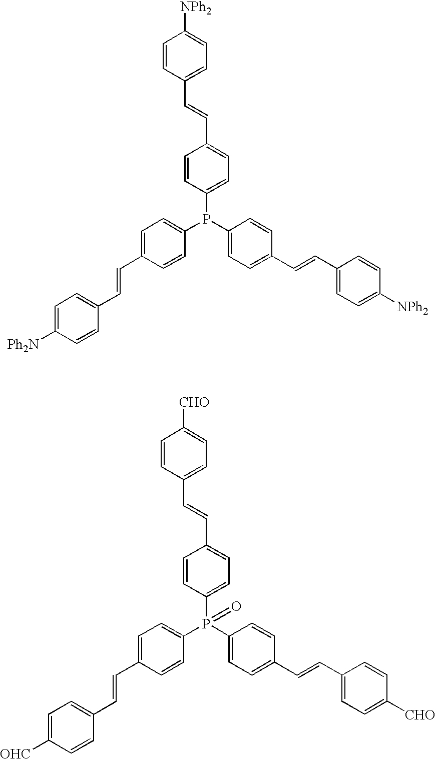
   in electronic devices, in particular in organic light-emitting diodes (O-LEDs), organic field-effect transistors (O-FETs), organic light-emitting transistors (O-LETs), organic thin-film transistors (O-TFTs), organic integrated circuits (O-ICs), organic solar cells (O-SCs), organic field-quench devices (O-FQDs) or organic laser diodes (O-lasers), particularly preferably in organic light-emitting diodes (O-LEDs).

For the purposes of this invention, an aryl group or heteroaryl group is taken to mean an aromatic group or heteroaromatic group respectively having a common aromatic electron system. For the purposes of this invention, this can be a simple homocycle or heterocycle, for example benzene, pyridine, thiophene, etc., or it can be a condensed aromatic ring system in which at least two aromatic or heteroaromatic rings, for example benzene rings, are “fused” to one another, i.e. are condensed onto one another by anellation, i.e. have at least one common edge and consequently also a common aromatic system. These aryl or heteroaryl groups may be substituted or unsubstituted ; any substituents present may likewise form further ring systems. Thus, for example, systems such as naphthalene, anthracene, phenanthrene, pyrene, etc., are to be regarded as aryl groups and quinoline, acridine, benzothiophene, carbazole, etc., are to be regarded as heteroaryl groups for the purposes of this invention, while, for example, biphenyl, fluorene, spirobifluorene, etc., do not represent aryl groups since these involve separate aromatic electron systems.

For the purposes of the present invention, an alkyl group, in which, in addition, individual H atoms or CH₂ groups may be interrupted by the above-mentioned groups, are particularly preferably taken to mean the radicals methyl, ethyl, n-propyl, i-propyl, n-butyl, i-butyl, s-butyl, t-butyl, 2-methylbutyl, n-pentyl, s-pentyl, cyclopentyl, n-hexyl, cyclohexyl, n-heptyl, cycloheptyl, n-octyl, cyclooctyl, 2-ethylhexyl, trifluoromethyl, pentafluoroethyl, 2,2,2-trifluoroethyl, ethenyl, propenyl butenyl, pentenyl, cyclopentenyl, hexenyl, cyclohexenyl, heptenyl, cycloheptenyl, octenyl, cyclooctenyl, ethynyl, propynyl, butynyl, pentynyl, hexynyl or octynyl. An alkoxy group is particularly preferably taken to mean methoxy, ethoxy, n-propoxy, i-propoxy, n-butoxy, i-butoxy, s-butoxy, t-butoxy or 2-methylbutoxy. An aryl or heteroaryl group, which may be monovalent or divalent depending on the use, which may also in each case be substituted by the above-mentioned radicals R¹⁰ and which may be linked to aromatics or heteroaromatics via any desired positions, is taken to mean, in particular, groups derived from benzene, naphthalene, anthracene, phenanthrene, pyrene, chrysene, perylene, fluoranthene, tetracene, pentacene, benzopyrene, furan, benzofuran, isobenzofuran, dibenzofuran, thiophene, benzothiophene, isobenzothiophene, dibenzothiophene, pyrrole, indole, isoindole, carbazole, pyridine, quinoline, isoquinoline, acridine, phenanthridine, benzo-5,6-quinoline, benzo-6,7-quinoline, benzo-7,8-quinoline, phenothiazine, phenoxazine, pyrazole, indazole, imidazole, benzimidazole, naphthimidazole, phenanthrimidazole, pyridimidazole, pyrazinimidazole, quinoxalinimidazole, oxazole, benzoxazole, naphthoxazole, anthroxazole, phenanthroxazole, isoxazole, 1,2-thiazole, 1,3-thiazole, benzothiazole, pyridazine, benzopyridazine, pyrimidine, benzopyrimidine, quinoxaline, pyrazine, phenazine, naphthyridine, azacarbazole, benzocarboline, phenanthroline, 1,2,3-triazole, 1,2,4-triazole, benzotriazole, 1,2,3-oxadiazole, 1,2,4-oxadiazole, 1,2,5-oxadiazole, 1,3,4-oxadiazole, 1,2,3-thiadiazole, 1,2,4-thiadiazole, 1,2,5-thiadiazole, 1,3,4-thiadiazole, 1,3,5-triazine, 1,2,4-triazine, 1,2,3-triazine, tetrazole, 1,2,4,5-tetrazine, 1,2,3,4-tetrazine, 1,2,3,5-tetrazine, purine, pteridine, indolizine and benzothiadiazole.

The systems formed by combination of these systems and formation of additional ring systems are preferably biphenylene, terphenylene, fluorene, spirobifluorene, dihydrophenanthrene, dihydropyrene, tetrahydropyrene or cis- or trans-indenofluorene.

Preference is given to compounds of the formula (1) in which the symbol Y stands for phosphorus, oxygen or sulfur, particularly preferably for phosphorus or oxygen, very particularly preferably for phosphorus.

Preference is given to compounds of the formula (1) in which the symbol X stands for oxygen, sulfur or a free electron pair, particularly preferably for oxygen or a free electron pair.

Very particular preference is given to compounds of the formula (1) in which, in the case where the radical Y stands for phosphorus, X stands for a free electron pair, Ar¹ stands for phenyl, n and q are equal to 1, p is equal to 3, R¹ and R² stand for hydrogen and Ar² stands for a phenyl radical which is substituted by a radical R¹⁰, the radical R¹⁰ does not stand for NPh₂. The radical Ph stands for an unsubstituted phenyl radical.

Very particular preference is given to compounds of the formula (1) in which, in the case where the radical Y stands for phosphorus, X stands for oxygen, Ar¹ stands for phenyl, n and q are equal to 1, p is equal to 3, R¹ and R² stand for hydrogen and Ar² stands for a phenyl radical which is substituted by a radical R¹⁰, the radical R¹⁰ does not stand for CHO.

Preference is furthermore given to compounds of the formula (1) in which the symbols Ar¹ and Ar², identically or differently on each occurrence, stand for an aryl group having 6 to 16 C atoms or a heteroaryl group having 2 to 16 C atoms, each of which may be substituted by one or two radicals R¹⁰, particularly preferably for an aryl group having 6 to 14 C atoms or a heteroaryl group having 4 to 14 C atoms, each of which may be substituted by one or two radicals R¹⁰, very particularly preferably for an aryl or heteroaryl group selected from benzene, naphthalene, anthracene, phenanthrene, pyridine and thiophene, in particular benzene, each of which may be substituted by one or two radicals R¹⁰.

Preference is furthermore given to compounds of the formula (1) in which the symbols R¹ and R², identically or differently on each occurrence, stand for H, CN, a straight-chain alkyl group having 1 to 20 C atoms or a branched alkyl group having 3 to 20 C atoms, in which one or more non-adjacent CH₂ groups may be replaced by —R²⁰C═CR²⁰—, —C≡C—, —O— or —S— and in which one or more H atoms may be replaced by F, or an aryl group having 6 to 16 C atoms or a heteroaryl group having 2 to 16 C atoms, each of which may be substituted by one or more radicals R¹⁰, or R¹, R² each, independently of one another, can form a cyclic system together with the radical Ar¹ and/or Ar².

The symbols R¹ and R² particularly preferably stand for H, CN, methyl, ethyl, propyl, i-propyl, n-, sec- or tert-butyl, or a phenyl group or heteroaryl group having 4 to 6 C atoms, which may be substituted by one or more radicals R¹⁰, and/or R¹ or R² each, independently of one another, form a cyclic system together with the radical Ar¹ and/or Ar². The symbols R¹ and R² very particularly preferably stand for H.

Preference is furthermore given to compounds of the formula (1) in which the symbol R¹⁰, identically or differently on each occurrence, stands for H, F, CN, a straight-chain alkyl or alkoxy group having 1 to 20 C atoms, a branched alkyl or alkoxy group having 3 to 20 C atoms, a cyclic alkyl or alkoxy group having 5 to 20 C atoms, each of which may be substituted by one or more radicals R²⁰, where one or more non-adjacent CH₂ groups may be replaced by —R²⁰C═CR²⁰—, —C≡C—, Si(R²⁰)₂, C═O, —O— or —S— and where one or more H atoms may be replaced by F, or an aryl group having 6 to 16 C atoms or a heteroaryl group having 2 to 16 C atoms, each of which may be substituted by one or more radicals R²⁰, or an aryloxy or heteroaryloxy group having 2 to 16 aromatic C atoms, which may be substituted by one or more radicals R²⁰, or a combination of two, three, four or five of these systems; two or more substituents R¹⁰ here, both on the same ring and also on different rings, may also form a mono- or polycyclic, aliphatic or aromatic ring system with one another or form a ring system together with a radical R¹ and/or R².

Preference is furthermore given to compounds of the formula (1) in which the symbols Ar¹ and Ar², identically or differently on each occurrence, stand for a phenyl group or a heteroaryl group having 4 to 6 C atoms, R¹ and R², identically or differently on each occurrence, stand for H, a straight-chain alkyl group having 1 to 10 C atoms or a branched alkyl group having 3 to 4 C atoms, in which one or more non-adjacent CH₂ groups may be replaced by —O— or —S— and in which one or more H atoms may be replaced by F, and the radical R¹⁰ on each occurrence, identically or differently, stands for H, F, Br, CN,

a straight-chain alkyl group having 1 to 10 C atoms, where, in the above-mentioned alkyl group, one or more non-adjacent CH₂ groups may, independently of one another, be replaced by —O— or —S— and where one or more H atoms may be replaced by F, Cl, Br, I, CN or NO₂,

or an aryl group having 6 to 14 C atoms, in particular benzene, naphthalene, anthracene and phenanthrene, or a heteroaryl group having 2 to 10 C atoms, in particular pyridine and thiophene, each of which may be substituted by one or more radicals R²⁰

or an aryloxy group having 6 to 10 aromatic C atoms or a heteroaryloxy group having 2 to 10 aromatic C atoms, each of which may be substituted by one or more radicals R²⁰.

The radical R¹⁰ is particularly preferably bonded to the radical Ar², in particular in the ortho- or para-position, very particularly preferably in the para-position.

Preference is furthermore given to compounds in which the sum of the indices n and m is at least the integer 1.

Preference is furthermore given to compounds in which the index n, identically or differently on each occurrence, stands for 1, 2 or 3, particularly preferably for 1 or 2, very particularly preferably for 1.

Preference is furthermore given to compounds in which the index m, identically or differently on each occurrence, stands for 1, 2 or 3, particularly preferably for 1 or 2, very particularly preferably for 1.

Preference is furthermore given to compounds in which the index q, identically or differently on each occurrence, stands for 1, 2 or 3, particularly preferably for 1 or 2, very particularly preferably for 1.

The aryl or heteroaryl groups Ar¹—and in the case of an Ar² which is substituted by an aryl radical (R¹⁰)—preferably have an even number of aromatic ring atoms between the two linking points. In particular, the radical Ar¹ and also the above-mentioned radical Ar² have a number of ring atoms which can be divided by four. Thus, for example for phenylene systems, ortho- and para-linking are preferred, in particular para-linking.

Particular preference is given to compounds of the formula (1) which have a symmetrical structure and have a three-fold axis of rotation, which relates not only to the aromatic groups Ar¹ and Ar², but particularly preferably also to the radicals R¹ and R². This preference is due to the easier synthetic accessibility of the compounds. However, the asymmetrical compounds are also accessible in more steps.

If the compound can exhibit atropisomerism about one or more bonds, the invention in each case also relates to the isolated or enriched atropisomers. This relates both to enantiomers and also to diastereomers. The choice of suitable atropisomers enables, for example, the solubility of the compound to be influenced.

Examples of preferred compounds of the formula (1) are Examples 1 to 63 depicted below.

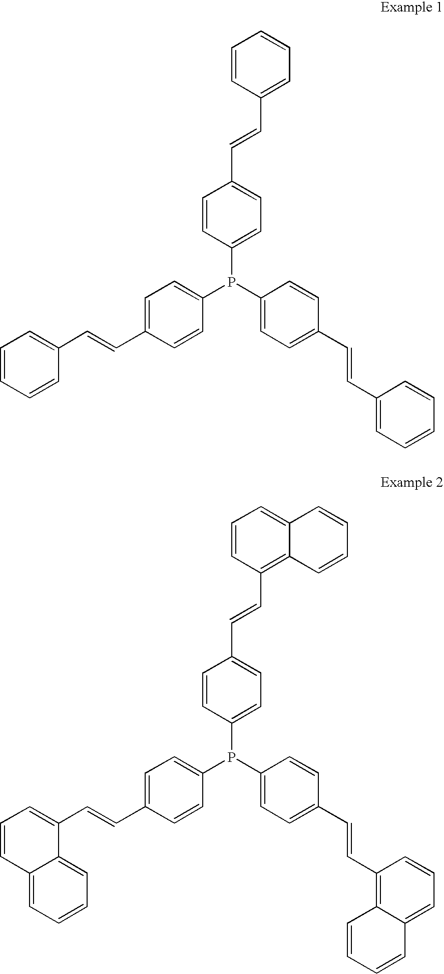

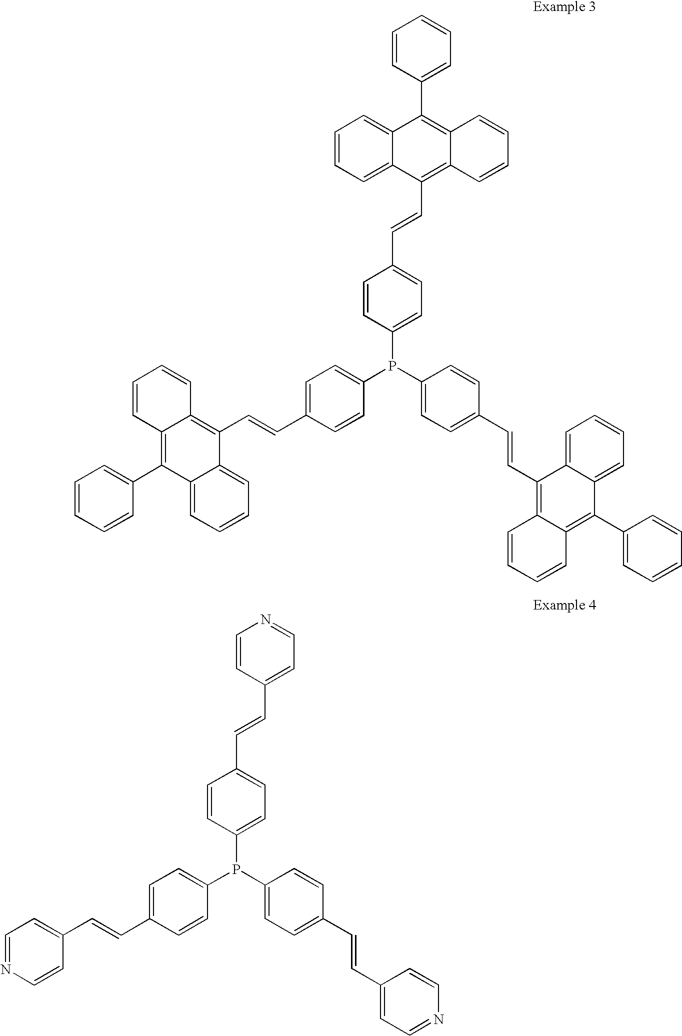

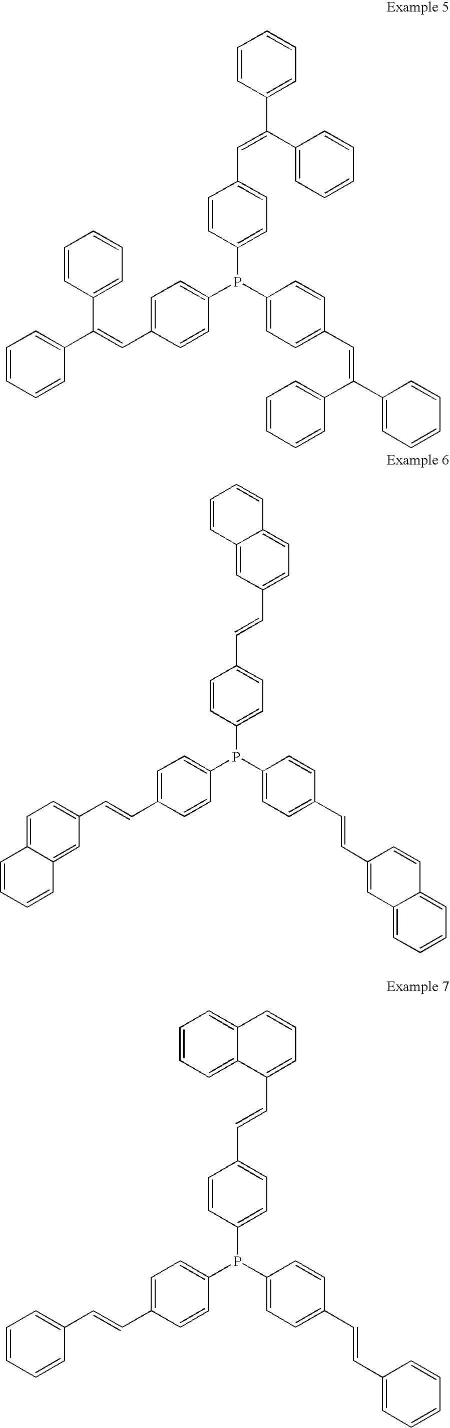

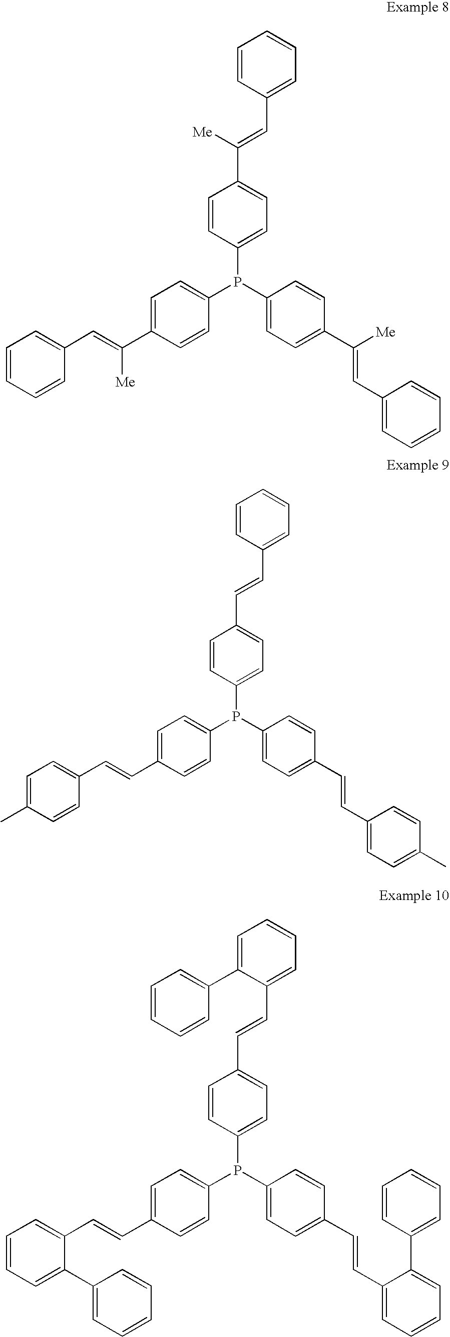

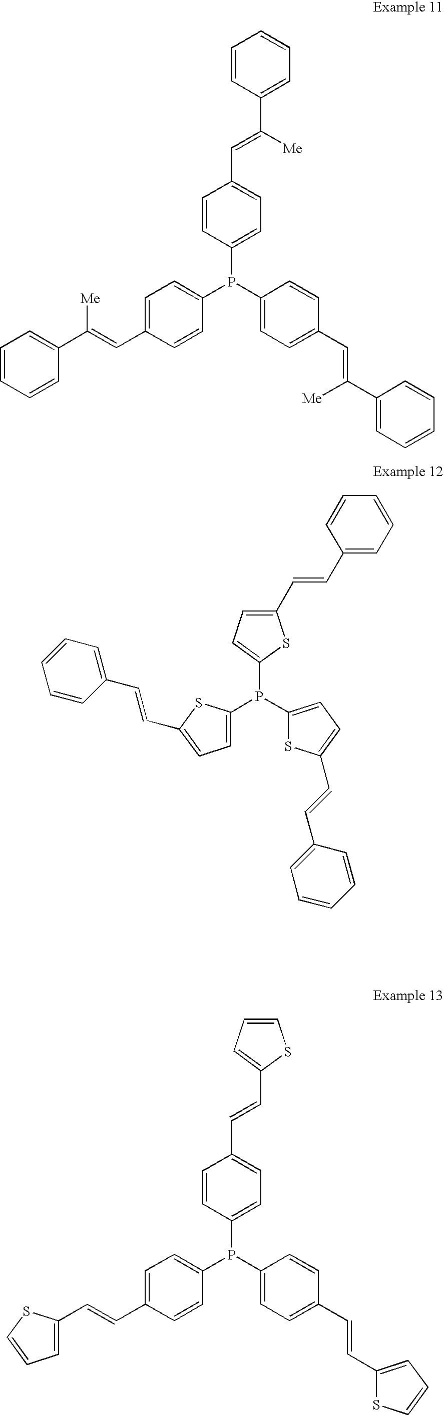

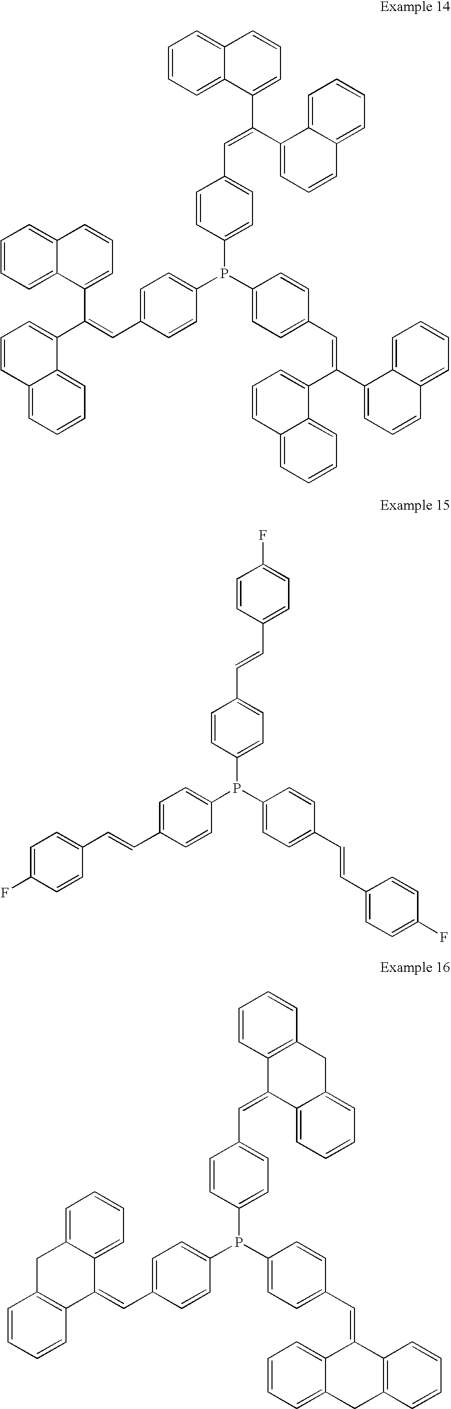

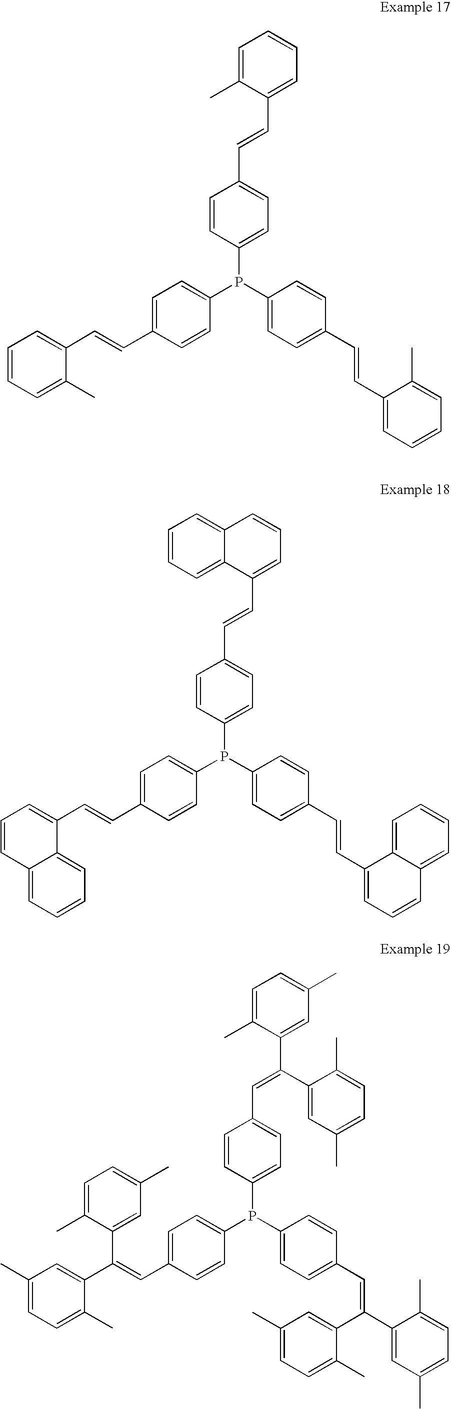

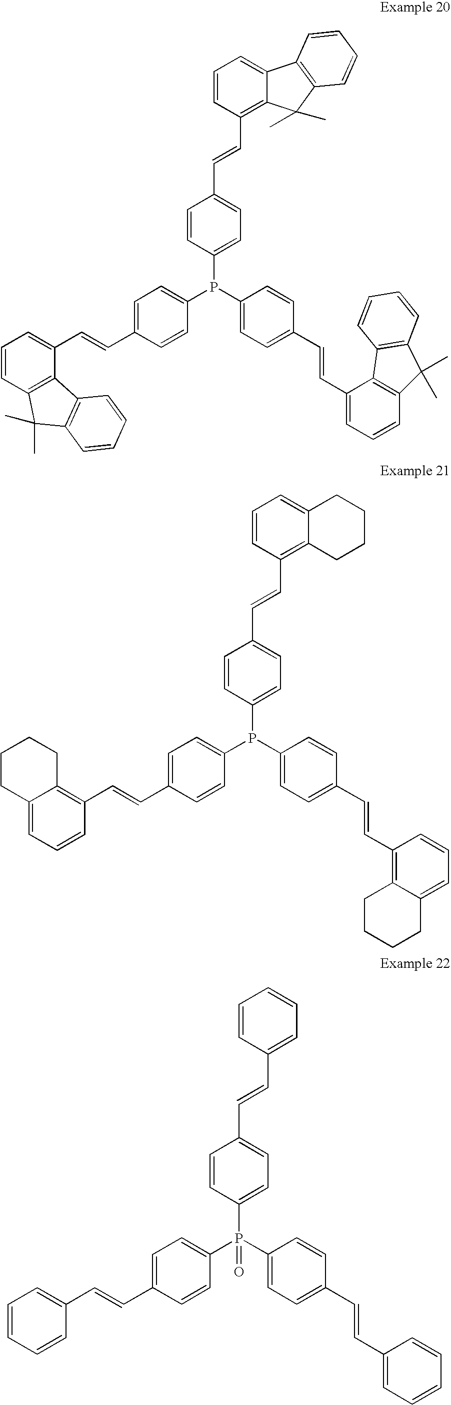

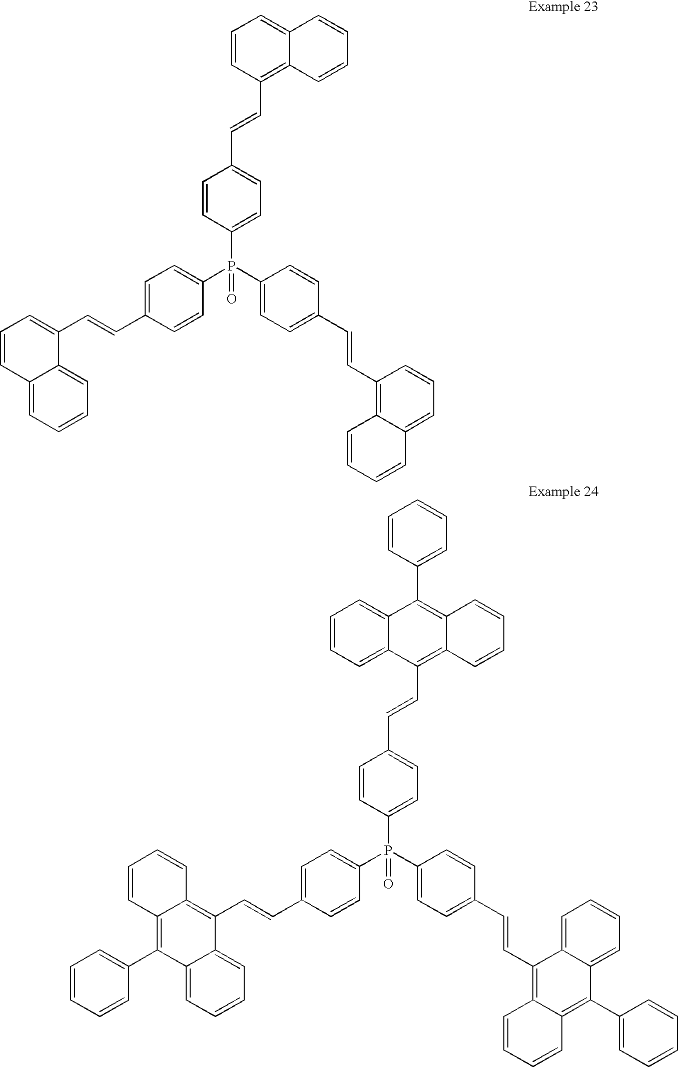

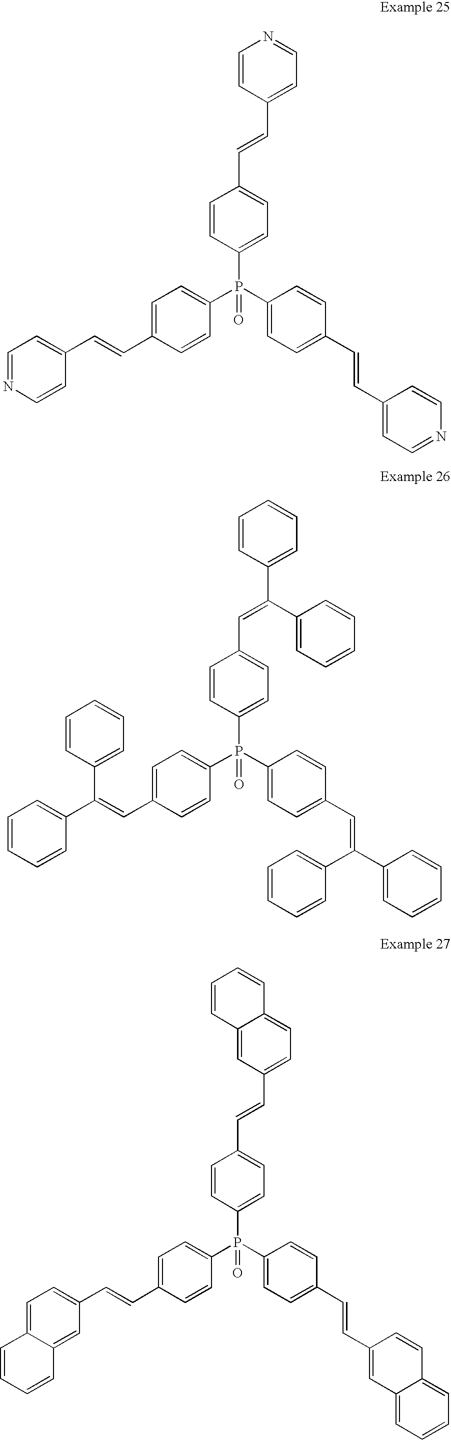

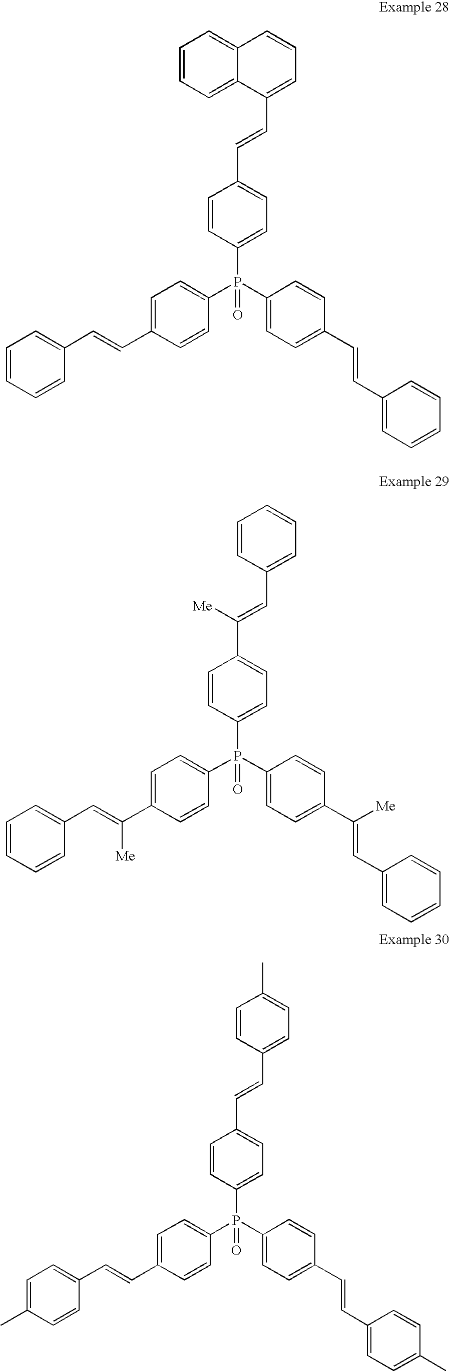

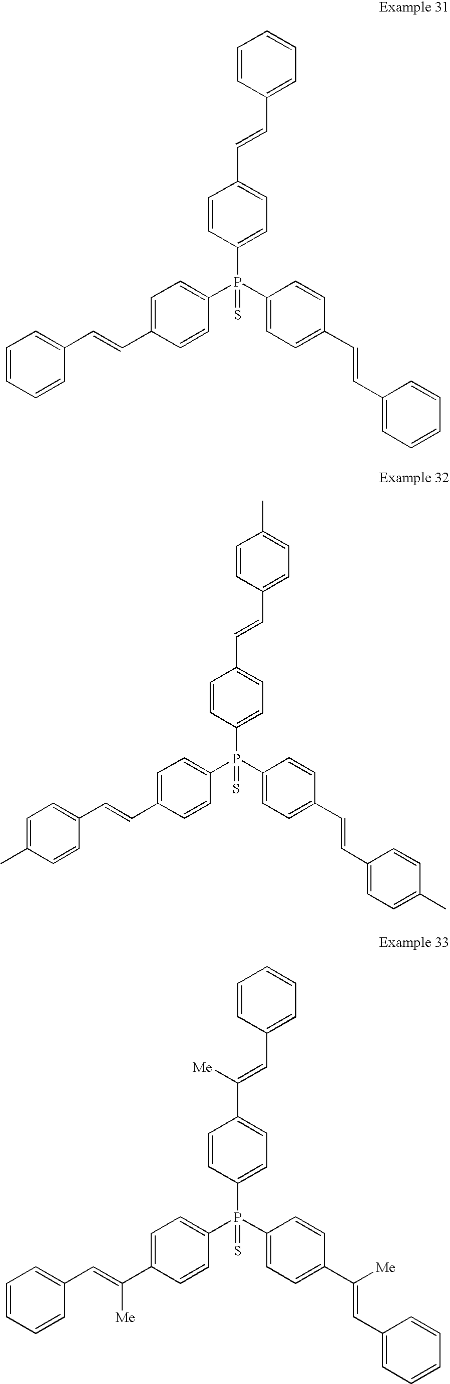

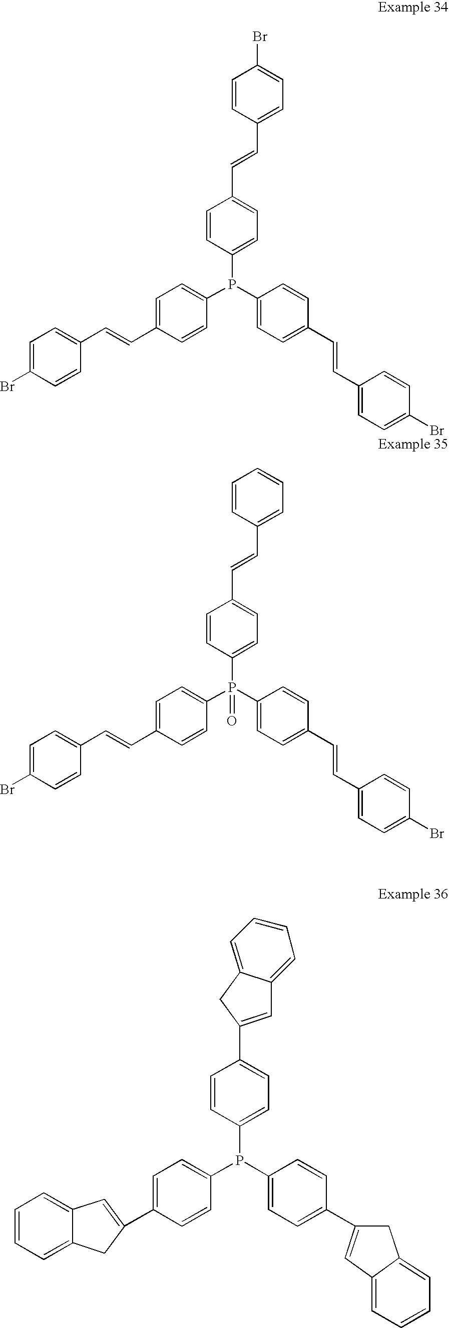

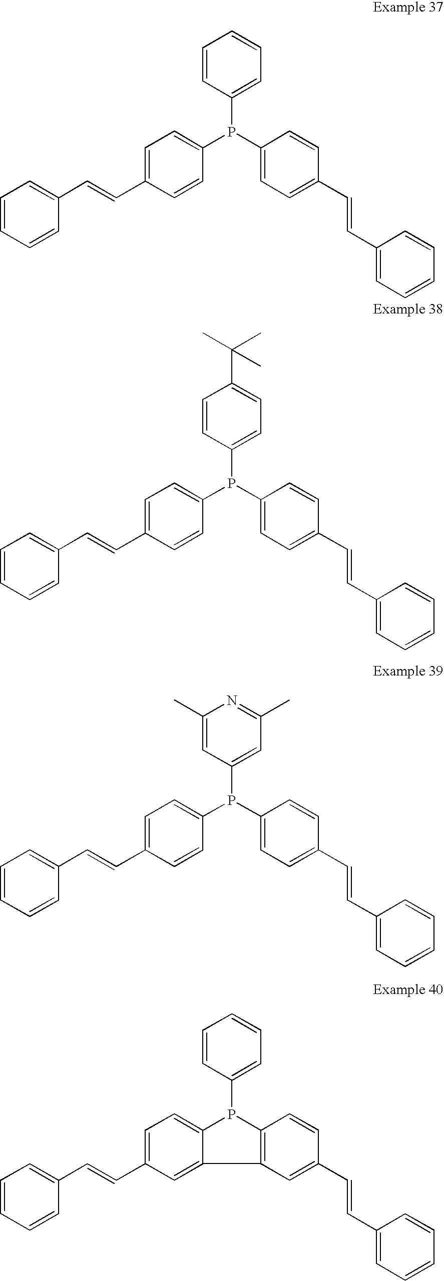

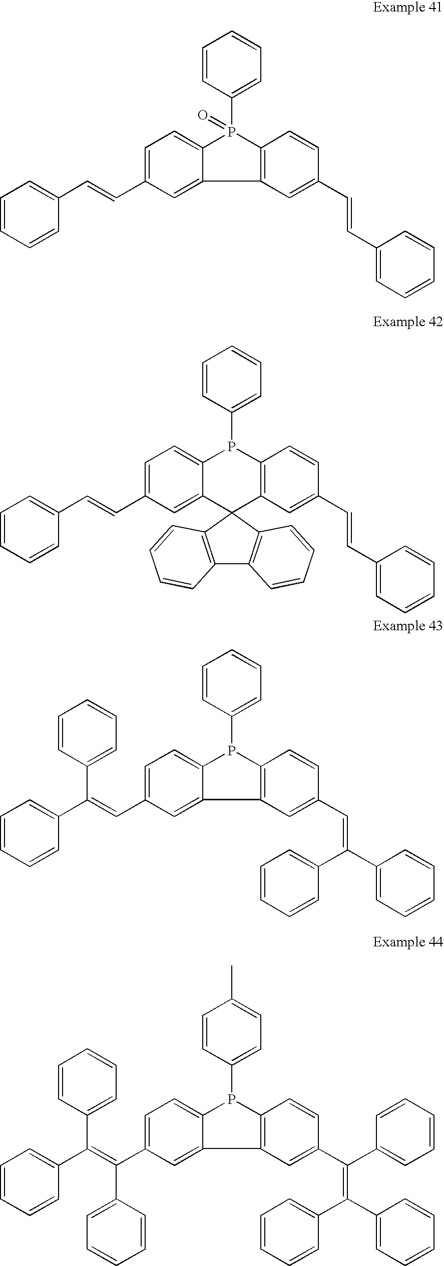

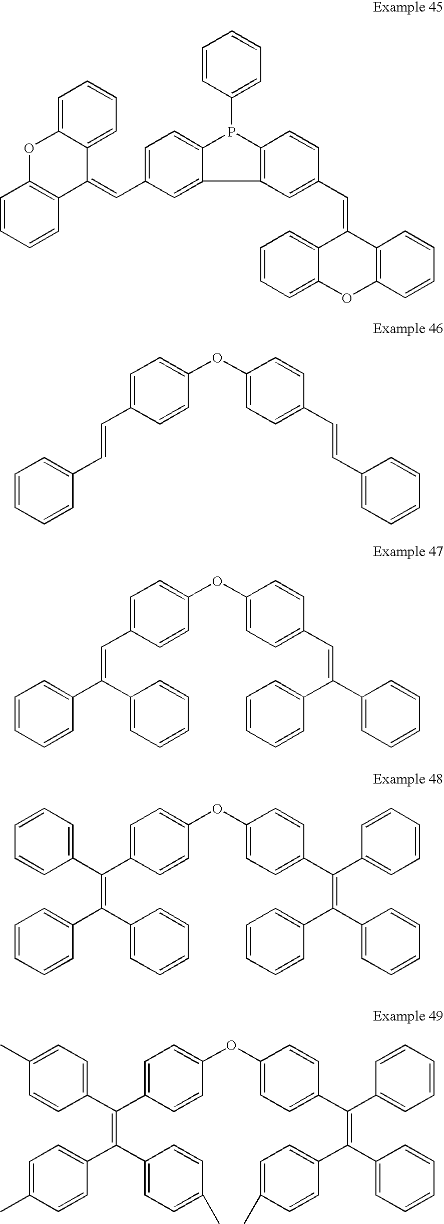

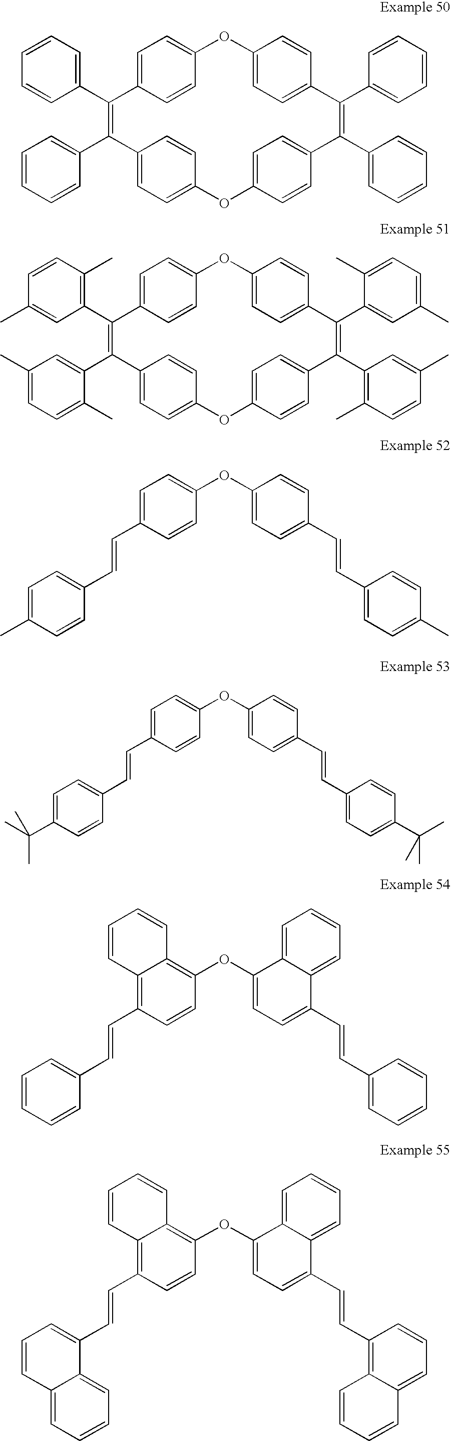

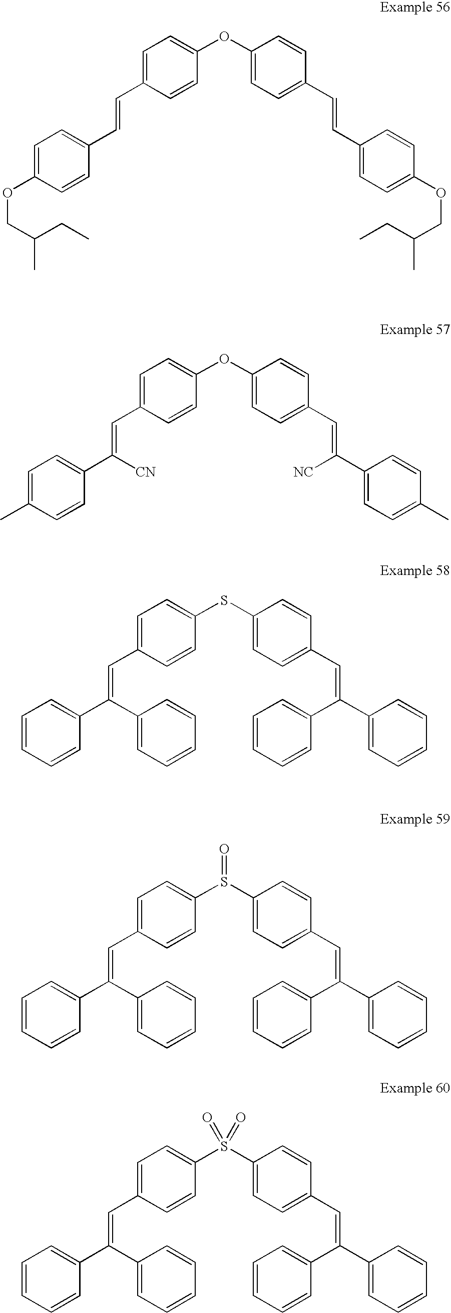

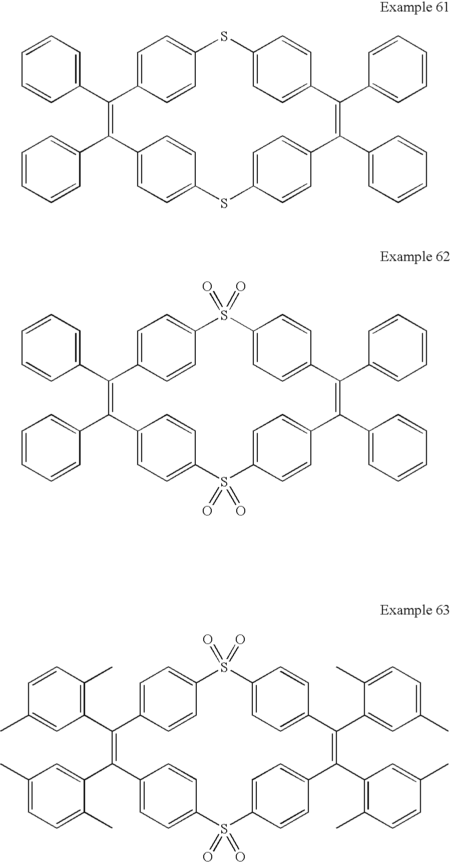

The compounds according to the invention can be prepared by synthetic steps known to the person skilled in the art, such as, for example, bromination, Suzuki coupling, Wittig-Horner reaction, etc. Triarylphosphines can easily be synthesised, for example, by salt metathesis from arylmetal compounds (for example aryllithium compounds or aryl-Grignard compounds) by reaction with phosphorus trihalides. Bromination of these triarylphosphines leads to tris-p-bromine-substituted triarylphosphines, with very good yields frequently being achieved here—due to the +M-directing effect of the phosphorus atom—at the same time as excellent regioselectivities. Brominating agents which can be used, besides elemental bromine, are, in particular, also N-bromo compounds, such as N-bromosuccinimide (NBS). The tris-p-bromine-substituted triarylphosphines prepared in this way can easily be reacted with functionalised arylboronic acids in excellent yields, for example by Suzuki coupling under standard conditions. Suitable functionalisations are, in particular, formyl, alkylcarbonyl and arylcarbonyl groups or protected analogues thereof, for example in the form of the corresponding dioxolanes. Furthermore, the tris-p-bromine-substituted triarylphosphines can be functionalised with aldehyde groups, for example by Vielsmeyer formylation, and can thus be employed as starting materials for Wittig-Horner reactions. It is of course also possible to use other coupling reactions (for example Stille coupling, Heck coupling, etc.). The resultant carbonyl substrates can then easily be converted into the corresponding olefins, for example by a Wittig-Horner reaction. Corresponding phosphine oxides are accessible by oxidation of the phosphines, for example using hydrogen peroxide. The synthesis of corresponding aromatic ethers can be carried out analogously, simple brominated diaryl ethers also being commercially available. Aromatic ethers can furthermore be synthesised by palladium-catalysed coupling reaction of an aromatic halide with a phenol and reacted further analogously to the above-described phosphines.

Suitably functionalised compounds of the formula (1), in particular brominated compounds, such as, for example, example structures 34 and 35 depicted above, can also be used for incorporation into polymers.

The invention therefore furthermore relates to conjugated, partially conjugated or non-conjugated polymers, oligomers or dendrimers comprising recurring units of the formula (1). These recurring units can be copolymerised, for example, into polyfluorenes (for example as described in EP 842208 or WO 00/22026), polyspirobifluorenes (for example as described in EP 707020, EP 894107 or EP 04028865.6), polyparaphenylenes (for example as described in WO 92/18552), polydihydrophenanthrenes (for example as described in WO 05/014689), polyphenanthrenes (for example as described in DE 102004020298.2), polyindenofluorenes (for example as described in WO 04/041901 or WO 04/113412), polycarbazoles (for example as described in WO 04/070772 or WO 04/113468), polyanthracenes, polynaphthalenes (for example as described in EP 04030093.1) or polythiophenes (for example as described in EP 1028136). Polymers having a plurality of these units or homopolymers of the recurring units of the formula (1) are also possible. The present invention likewise relates to the use of these polymers, oligomers or dendrimers in organic electronic devices.

The compounds of the formula (1) can be employed in organic electroluminescent devices, where the compound is preferably employed in the emitting layer and preferably as a mixture with at least one host material. It is preferred for the compound of the formula (1) to be the emitting compound (the dopant) in the mixture. Preferred host materials are organic compounds whose emission is of shorter wavelength than that of the compound of the formula (1) or which do not emit at all in the visible region. The use of the compounds of the formula (1) as hole-transport material is also possible.

The present invention furthermore relates to mixtures comprising at least one compound of the formula (1) 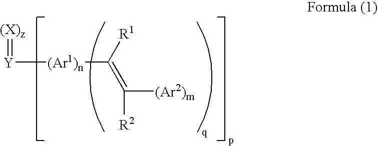
where the following applies to the symbols and indices used:
Y is on each occurrence phosphorus, arsenic, antimony, bismuth, oxygen, sulfur, selenium or tellurium, where, in the case of Y=oxygen, the radical X stands for a free electron pair and where, in the case of Y=sulfur, selenium or tellurium, the radical X, identically or differently on each occurrence, stands for a free electron pair or for oxygen;
X is on each occurrence, identically or differently, oxygen, sulfur, selenium, tellurium or stands for a free electron pair;
Ar¹ is on each occurrence, identically or differently, an aryl group having 6 to 24 C atoms or a heteroaryl group having 2 to 24 C atoms, which may be substituted by one or more radicals R¹⁰;
Ar² is on each occurrence, identically or differently, an aryl group having 6 to 24 C atoms or a heteroaryl group having 2 to 24 C atoms, which may be substituted by one or more radicals R¹⁰;
R¹, R² are on each occurrence, identically or differently, H, CN, F, a straight-chain alkyl group having 1 to 40 C atoms, a branched alkyl group having 3 to 40 C atoms, a cyclic alkyl group having 3 to 40 C atoms, where the above-mentioned alkyl groups may be substituted by one or more radicals R²⁰ and one or more non-adjacent CH₂ groups in the radical R¹ and/or R² may, independently of one another, be replaced by —R²⁰C═CR²⁰—, —C≡C—, Si(R²⁰)₂, Ge(R²⁰)₂, Sn(R²⁰)₂, C═O, C═S, C═Se, C═NR²⁰, —O—, —S—, —COOR²⁰— or —CONR²⁰— and where one or more H atoms may be replaced by F, Cl, Br, I, CN, SCN or NO₂,
   or an aromatic system having 6 to 40 aromatic C atoms or a heteroaromatic system having 2 to 40 aromatic C atoms, each of which may be substituted by one or more radicals R¹⁰,
   or an aryloxy group having 6 to 40 aromatic C atoms or a heteroaryloxy group having 2 to 40 aromatic C atoms, each of which may be substituted by one or more radicals R¹⁰, or
   R¹, R² may each, independently of one another, form a cyclic system together with the radical Ar¹ and/or Ar²;
R¹⁰ is on each occurrence, identically or differently, H, F, Cl, Br, 1, CN, NO₂, a straight-chain alkyl group having 1 to 40 C atoms, a branched alkyl group having 3 to 40 C atoms, a cyclic alkyl group having 3 to 40 C atoms, where the above-mentioned alkyl groups may be substituted by one or more radicals R²⁰ and one or more non-adjacent CH₂ groups in the radical R¹⁰ may, independently of one another, be replaced by —R²⁰C═CR²⁰—, —C≡C—, Si(R²⁰)₂, Ge(R²⁰)₂, Sn(R²)₂, C═O, C═S, C═Se, C═NR²⁰, —O—S—, —COOR²⁰— or —CONR²⁰— and where one or more H atoms may be replaced by F, Cl, Br, I, CN or NO₂, or an aryl group having 6 to 24 C atoms or a heteroaryl group having 2 to 24 C atoms, each of which may be substituted by one or more radicals R²⁰,
   or an aryloxy group having 6 to 24 aromatic C atoms or a heteroaryloxy group having 2 to 24 aromatic C atoms, each of which may be substituted by one or more radicals R²⁰,
   or a combination of two, three, four or five of these systems; two or more substituents R¹⁰ here, both on the same ring and also on different rings, may also form a mono- or polycyclic, aliphatic or aromatic ring system with one another or a ring system together with a radical R¹ and/or R²;
R²⁰ is on each occurrence, identically or differently, H or an aliphatic or aromatic hydrocarbon radical having 1 to 20 C atoms;
n is identical or different on each occurrence and stands for an integer 0, 1, 2, 3, 4 or 5;
m is identical or different on each occurrence and stands for an integer 0, 1, 2, 3, 4 or 5;
q is identical or different on each occurrence and stands for an integer 0, 1, 2, 3, 4 or 5, with the proviso that at least one index q is ≠zero;
p stands for the integer 2 in the case where the radical Y stands for an element from main group 6 of the Periodic Table and stands for the integer 3 in the case where the radical Y stands for an element from main group 5 of the Periodic Table;
Z stands for the integer 1 in the case where Y stands for an element from main group 5 of the Periodic Table and stands for the integer 2 in the case where Y stands for an element from main group 6 of the Periodic Table;
   and
   at least one host material.

The preferred embodiments described above will not be repeated at this point. All preferred embodiments of the compounds of the formula (1) also apply to the mixture according to the invention comprising at least one compound of the formula (1) and at least one host material.

Suitable host materials are various classes of substance. Preferred host materials are selected from the classes of the oligoarylenes (for example 2,2′,7,7′-tetraphenyl-spirobifluorene as described in EP 676461 or dinaphthylanthracene), in particular the oligoarylenes containing condensed aromatic groups, the oligoarylenevinylenes (for example DPVBi or spiro-DPVBi as described in EP 676461), the polypodal metal complexes (for example as described in WO 04/081017), the hole-conducting compounds (for example as described in WO 04/058911), the electron-conducting compounds, in particular ketones, phosphine oxides, sulfoxides, etc. (for example as described in the as yet unpublished application DE 102004008304.5), or the atropisomers (for example as described in the as yet unpublished application EP 04026402.0). Particularly preferred host materials are selected from the classes of the oligoarylenes comprising naphthalene, anthracene and/or pyrene or atropisomers of these compounds, the oligoarylenevinylenes, the ketones, the phosphine oxides and the sulfoxides. Very particularly preferred host materials are selected from the classes of the oligoarylenes comprising anthracene and/or pyrene or atropisomers of these compounds, the phosphine oxides and the sulfoxides.

The proportion of the compound of the formula (1) in the mixture is between 0.1 and 99.0% by weight, preferably between 0.5 and 50.0% by weight, particularly preferably between 1.0 and 20.0% by weight, especially between 1.0 and 10.0% by weight. Correspondingly, the proportion of the host material in the mixture is between 1.0 and 99.9% by weight, preferably between 50.0 and 99.5% by weight, particularly preferably between 80.0 and 99.0% by weight, especially between 90.0 and 99.0% by weight.

Preference is furthermore given to organic electroluminescent devices, characterised in that a plurality of emitting compounds are used in the same layer or in different layers, where at least one of these compounds has a structure of the formula (1). These compounds particularly preferably have in total a plurality of emission maxima between 380 nm and 750 nm, resulting overall in white emission, i.e. at least one further emitting compound which is able to fluoresce or phosphoresce and emits yellow, orange or red light is used in addition to the compound of the formula (1). Particular preference is given to three-layer systems, where at least one of these layers comprises a compound of the formula (1) and where the layers exhibit blue, green and orange or red emission (for the basic structure see, for example, WO 054011013).

Apart from the cathode, anode and emitting layer, the organic electroluminescent device may also comprise further layers. These can be, for example: hole-injection layer, hole-transport layer, electron-transport layer and/or electron-injection layer. However, it should be pointed out at this point that each of these layers does not necessarily have to be present. Thus, in particular in the case of the use of compounds of the formula (1) with electron-conducting host materials, very good results are furthermore obtained if the organic electroluminescent device does not comprise a separate electron-transport layer and the emitting layer is directly adjacent to the electron-injection layer or to the cathode. Alternatively, the host material may also simultaneously serve as electron-transport material in an electron-transport layer. It may likewise be preferred if the organic electroluminescent device does not comprise a separate hole-transport layer and the emitting layer is directly adjacent to the hole-injection layer or to the anode. It may furthermore be preferred if the compound of the formula (1) is not used or is not used only as dopant in the emitting layer, but also as hole-conducting compound (as the pure substance or as a mixture) in a hole-transport layer.

Preference is furthermore given to an organic electroluminescent device, characterised in that one or more layers are coated by means of a sublimation method, in which the materials are vapour-deposited in vacuum sublimation units at a pressure below 10⁻⁵ mbar, preferably below 10⁻⁶ mbar, particularly preferably below 10⁻⁷ mbar.

Preference is likewise given to an organic electroluminescent device, characterised in that one or more layers are coated by means of the OVPD (organic vapour phase deposition) method or with the aid of carrier-gas sublimation, where the materials are applied at a pressure between 10⁻⁵ mbar and 1 bar.

Preference is furthermore given to an organic electroluminescent device, characterised in that one or more layers are produced from solution, such as, for example, by spin coating, or by means of any desired printing process, such as, for example, screen printing, flexographic printing or offset printing, but particularly preferably LITI (light induced thermal imaging, thermal transfer printing) or ink-jet printing. This requires soluble compounds of the formula (1). High solubility can be achieved, for example, by suitable substitution of the compounds.

The compounds according to the invention have the following surprising advantages over the prior art on use in organic electroluminescent devices:

1. The efficiency of corresponding devices becomes higher compared with systems in accordance with the prior art.

2. The stability of corresponding devices becomes higher compared with systems in accordance with the prior art, which is evident, in particular, from a significantly longer lifetime.

3. In organic electroluminescent devices, the compounds of the formula (1) exhibit significantly darker-blue emission than stilbenamines in accordance with the prior art. This is of crucial importance, in particular for full-colour displays.

4. The compounds can be sublimed and vapour-deposited well and without considerable decomposition, are consequently easier to process and are therefore more suitable for use in OLEDs than materials in accordance with the prior art.

The present invention thus furthermore relates to an electrical device, preferably an organic electroluminescent device, which has at least one layer which comprises at least one compound of the formula (1) or a mixture of at least one compound of the formula (1) and at least one host material.

The present application text and also the examples below are directed to the use of compounds according to the invention in relation to OLEDs and the corresponding displays. In spite of this restriction of the description, it is possible for the person skilled in the art, without further inventive step, also to use the compounds according to the invention for further uses in other electronic devices, for example for organic field-effect transistors (O-FETs), organic thin-film transistors (O-TFTs), organic integrated circuits (O-ICs), organic solar cells (O-SCs) or organic laser diodes (O-lasers), to mention but a few applications.

The present invention likewise relates to the use of the compounds according to the invention in the corresponding devices and to these devices themselves.

The invention is explained in greater detail by the following examples without wishing it to be restricted thereby.

### EXAMPLES

The following syntheses were carried out under a protective-gas atmosphere, unless indicated otherwise. The starting materials were purchased from ALDRICH or ABCR (bis(4-bromophenyl)ether, 1,1-diphenylethene, N,N-dimethylglycine, palladium(II) acetate, inorganics, solvents). Tris(4-formylphenyl)phosphine was prepared by the method of Chalier et al., J. Phys. Chem. 1996, 100(10), 4323.

### Example 1

### Synthesis of bis(4-(1,1-diphenyl-2-vinyl)phenyl)ether, dopant D1

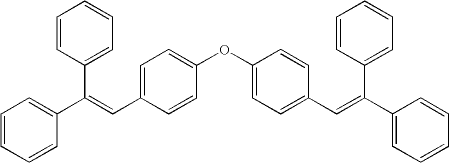

A degassed suspension of 32.8 g (100 mmol) of bis(4-bromophenyl)ether, 53.0 ml (300 mmol) of 1,1-diphenylethene, 449 mg (2 mmol) of palladium(II) acetate, 32 mg (0.2 mmol) of iron(III) chloride, 2.1 g (20 mmol) of N,N-dimethylglycine and 46.2 g (550 mmol) of sodium hydrogencarbonate in 500 ml of N-methylpyrrolidone was heated at 145° C. for 16 h. After cooling, 1000 ml of dichloromethane and 1000 ml of water were added to the suspension. The org. phase was separated off, washed three times with 1000 ml of water, dried over magnesium sulfate and then filtered through a short silica-gel column. The yellow solid obtained after removal of the dichloromethane was recrystallised four times from DMSO (2 ml/g). After washing twice with 500 ml of boiling ethanol each time and drying the solid under reduced pressure, the latter was sublimed at T=290° C., p=5×10⁻⁵ mbar. Yield: 23.6 g (45 mmol), 44.8% of theory, purity according to HPLC 99.9%.

¹H-NMR (CDCl₃): δ [ppm]=7.42-7.24 (m, 20H), 6.90 (s, 2H), 6.88 (d, 4H), 6.81 (d, 4H).

### Example 2

### Synthesis of tris(4-stilbenyl)phosphine, dopant D2

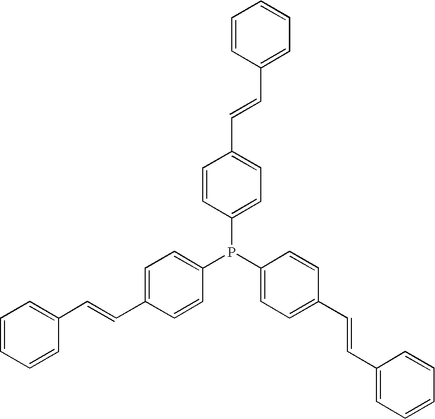

46.1 g (480 mmol) of sodium tert-butoxide were added with vigorous stirring at 0° C. to a mixture of 50.0 ml (240 mmol) of diethyl phenylmethanephosphonate and 1000 ml of DMF. A 30° C. solution of 22.9 g (66 mmol) of tris(4-formylphenyl)phosphine in 1000 ml of DMF was slowly added dropwise to this mixture at 0-10° C. When the addition was complete, the mixture was stirred at 0° C. to 10° C. for a further 3 h and at room temperature for 12 h. 100 ml of 2.5N HCl, then 300 ml of water and then 300 ml of ethanol were subsequently added. The yellow microcrystalline precipitate was filtered off with suction (P3), washed three times with 200 ml of a mixture of ethanol/water (1:1, v:v) each time and three times with 200 ml of ethanol each time. After drying under reduced pressure, the solid was recrystallised four times from DMF (about 3 ml/g) with exclusion of light. After washing twice with 300 ml of boiling ethanol each time and drying of the solid under reduced pressure, the latter was sublimed at T=320° C., p=5×10⁻⁵ mbar. Yield: 24.9 g (44 mmol), 66.3% of theory, purity according to HPLC 99.9% over all isomers, proportion of cis-isomeric double bonds in the sublimate about 10%.

³¹P-NMR (tetrachloroethane-d2): δ [ppm]=−11.3 (s, main peak, all-trans isomer).

### Example 3

### Synthesis of tris(4-stilbenyl)phosphine oxide, dopant D3

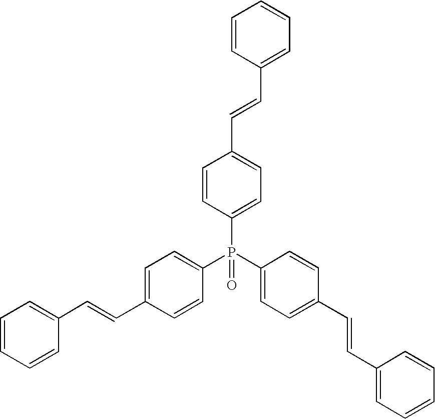

Tris(4-stilbenyl)phosphine oxide was prepared by the method of Xu et al. (J. Organo-met. Chem. 2003, 687(2), 301). The resultant solid was recrystallised four times from DMSO (2.5 ml/g) and then sublimed under reduced pressure at T=340° C., p=5×10⁻⁵ mbar. Yield on use of 100 mmol of tris(4-bromophenyl)phosphine oxide: 30.9 g (53 mmol), 52.9% of theory, purity according to HPLC 99.9% over all isomers, proportion of cis-isomeric double bonds in the sublimate about 8%.

³¹P-NMR (CDCl₃): δ [ppm]=34.3 (s, main peak, all-trans isomer).

### Example 4

### Production of OLEDs

OLEDs were produced by a general process as described in WO 04/058911, which was adapted in the individual case to the particular circumstances (for example layer-thickness variation in order to achieve optimum efficiency or colour).

The results for various OLEDs are presented in the following examples. The basic structure, the materials and layer thicknesses used, apart from the emitting layer and the hole-transport layer, were identical for better comparability. OLEDs having the following structure were produced analogously to the above-mentioned general process:

| | |
|---|---|
| Hole-injection | 20 nm PEDOT/PSS (spin-coated from aqueous |
| layer (HIL) | dispersion; purchased from H. C. Starck, Goslar, |
| | Germany; poly(3,4-ethylenedioxy-2,5-thiophene) + |
| | polystyrenesulfonic acid) |
| Hole-transport | 20 nm NaphDATA (vapour-deposited; purchased |
| layer (HTM) | from SynTec, Wolfen, Germany; 4,4′,4″-tris(N- |
| | 1-naphthyl-N-phenylamino)triphenylamine), 20 nm |
| | S-TAD (vapour-deposited; prepared as described |
| | in WO 99/12888;2,2′,7,7′- |
| | tetrakis(diphenylamino)spiro-9,9′-bifluorene) |
| | on top |
| Emission layer | see Table 1 for materials, concentration and |
| (EML) | layer thicknesses |
| Electron | 20 nm Alq3 (purchased from SynTec; |
| conductor (ETL) | tris(quinolinato)aluminium(III)) |
| LiF/Al (cathode) | 1 nm LiF, 150 nm Al on top |

These as yet unoptimised OLEDs were characterised by standard methods; for this purpose, the electroluminescence spectra, the efficiency (measured in cd/A), the power efficiency (measured in lm/W) as a function of the brightness, calculated from current/voltage/luminous density characteristic lines (IUL characteristic lines), and the lifetime were determined. The lifetime is defined as the time after which the initial brightness of 250 cd/m² has dropped to half.

Table 1 shows the results for some OLEDs, with the composition of the EML and HTL, including the layer thicknesses, also being shown in each case.

Examples 4a and 4b are comparative examples which either comprise only host material H1 or dopant D4 in accordance with the prior art doped into host material H1 in the emission layer.

Examples 4c-e according to the invention comprise dopants D1, D2 and D3 according to the invention as emitting materials doped into host material H1.

Structural formulae of the comparative dopants used and the host material:

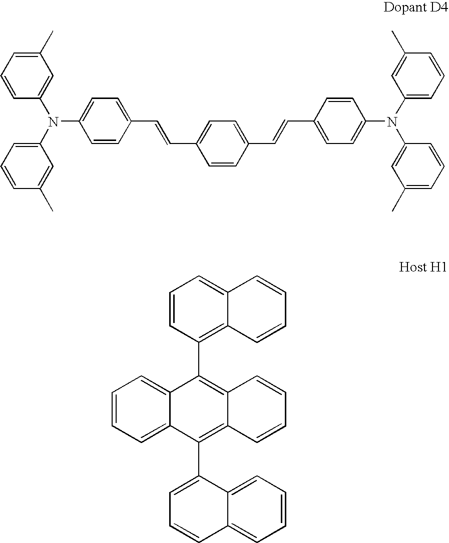

TABLE 1

| | | Max. | | | |
|---|---|---|---|---|---|
| | | effi- | Voltage | | |
| | | ciency | (V) at | | Lifetime |
| Example | EML | (cd/A) | 100 cd/m² | CIE ^{a} | (h) ^{b} |
| Example 4a | H1 | 1.1 | 5.8 | x = 0.17 | 1800 |
| (comparison) | (30 nm) | | | y = 0.19 | |
| Example 4b | H1:D4 (2%) | 5.2 | 6.5 | x = 0.18 | 4500 |
| (comparison) | (30 nm) | | | y = 0.34 | |
| Example 4c | H1:D1 (2%) | 2.0 | 5.7 | x = 0.13 | 1700 |
| | (30 nm) | | | y = 0.09 | |
| Example 4d | H1:D2 (2%) | 1.7 | 5.8 | x = 0.12 | 1500 |
| | (30 nm) | | | y = 0.08 | |
| Example 4e | H1:D3 (2%) | 1.5 | 5.5 | x = 0.10 | 1350 |
| | (30 nm) | | | y = 0.08 | |

^{a} CIE coordinates: colour coordinates of the Commission Internationale de I'Eclairage 1931.
^{b} Lifetime: time until the brightness drops to 50% of the initial brightness, measured at an initial brightness of 250 cd/m².

In summary, it can be stated that OLEDs comprising emitting compounds D1, D2 or D3 have a significantly darker-blue colour with continued very good efficiency and lifetime than materials in accordance with the prior art, as can easily be seen from Table 1. This is of crucial importance, in particular, for large-format displays which use the NTSC colour standard. These compounds are therefore more suitable for use in OLEDs than are materials in accordance with the prior art.

1-21. (canceled)

22. Compounds of the formula (1) 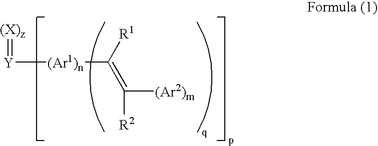
wherein:
Y is on each occurrence P, As, Sb, Bi, O, S, Se, or Te, and wherein when Y═O, X is a free electron pair, and wherein when Y═S, Se, or Te, X, identically or differently on each occurrence, is a free electron pair or O;
X is on each occurrence, identically or differently, O, S, Se, Te, or a free electron pair;
Ar¹ and Ar²
are on each occurrence, identically or differently, an aryl group having 6 to 24 C atoms or a heteroaryl group having 2 to 24 C atoms, wherein said aryl group and heteroaryl group is optionally substituted by one or more radicals R¹⁰;
R¹ and R²
are on each occurrence, identically or differently, H, CN, F, a straight-chain alkyl group having up to 40 C atoms, a branched alkyl group having 3 to 40 C atoms, or a cyclic alkyl group having 3 to 40 C atoms, wherein said straight-chain, branched, and cyclic alkyl groups are optionally substituted by one or more radicals R²⁰, and wherein one or more non-adjacent CH₂ groups in said straight-chain, branched, and cyclic alkyl groups are, independently of one another, optionally replaced by —R²⁰C═CR²⁰—, —C≡C—, Si(R²⁰)₂, Ge(R²⁰)₂, Sn(R²⁰)₂, C═O, C═S, C═Se, C═NR²⁰, —O—, —S—, —COOR²⁰— or —CONR²⁰—, and wherein one or more H atoms are optionally replaced by F, Cl, Br, I, CN, SCN, NO₂, an aromatic system having 6 to 40 aromatic C atoms, a heteroaromatic system having 2 to 40 aromatic C atoms, an aryloxy group having 6 to 40 aromatic C atoms or a heteroaryloxy group having 2 to 40 aromatic C atoms, wherein said aromatic system, heteroaromatic system, aryloxy group and heteroaryloxy group are optionally substituted by one or more radicals R¹⁰, and wherein R¹ and R², independently of one another, optionally define a cyclic system together with Ar¹ and/or Ar²;
R¹⁰ is on each occurrence, identically or differently, H, F, Cl, Br, I, CN, NO₂, a straight-chain alkyl group having up to 40 C atoms, a branched alkyl group having 3 to 40 C atoms, or a cyclic alkyl group having 3 to 40 C atoms, wherein said straight-chain, branched, and cyclic alkyl groups are optionally substituted by one or more radicals R²⁰, and wherein one or more non-adjacent CH₂ groups in said straight-chain, branched, and cyclic alkyl groups are, independently of one another, optionally replaced by —R²⁰C═CR²⁰—, —C≡C—, Si(R²⁰)₂, Ge(R²⁰)₂, Sn(R²⁰)₂, C═O, C═S, C═Se, C═NR²⁰, —O—, —S—, —COOR²⁰— or —CONR²⁰— and wherein one or more H atoms are optionally replaced by F, Cl, Br, I, CN, NO₂, an aryl group having 6 to 24 C atoms, a heteroaryl group having 2 to 24 C atoms, an aryloxy group having 6 to 24 aromatic C atoms, a heteroaryloxy group having 2 to 24 aromatic C atoms, wherein said aromatic system, heteroaromatic system, aryloxy group and heteroaryloxy group are optionally substituted by one or more radicals R²⁰, or a combination of two, three, four or five of these systems; and wherein two or more substituents R¹⁰, on the same ring and/or on different rings, optionally define a monocyclic or polycyclic aliphatic ring system or a monocyclic or polycyclic aromatic ring system with one another or together with R¹ and/or R²;
R²⁰ is on each occurrence, identically or differently, H or an aliphatic or aromatic hydrocarbon radical having up to 20 C atoms;
n is, identically or differently on each occurrence, 0, 1, 2, 3, 4 or 5;
m is, identically or differently on each occurrence, 0, 1, 2, 3, 4 or 5;
q is, identically or differently on each occurrence, 0, 1, 2, 3, 4 or 5, with the proviso that at least one q is does not equal 0;
p is 2 when Y is an element from main group 6 of the Periodic Table and is 3 when Y is an element from main group 5 of the Periodic Table;
z is 1 when Y is an element from main group 5 of the Periodic Table and is 2 when Y is an element from main group 6 of the Periodic Table; and
with the proviso that said compounds of formula (1) do not comprise

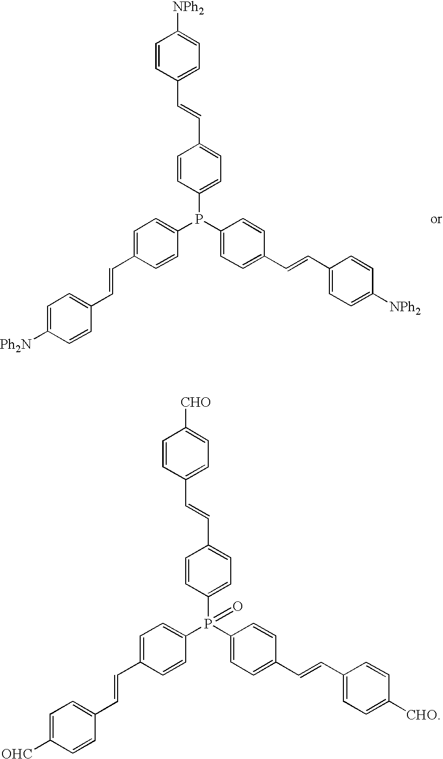

23. Compounds according to claim 22, wherein Y is P, O, or S.

24. Compounds according to claim 22, wherein X is O, S, or a free electron pair.

25. Compounds according to claim 22, wherein Ar¹ and Ar², identically or differently on each occurrence, are an aryl group having 6 to 16 C atoms or a heteroaryl group having 2 to 16 C atoms, wherein said aryl group and heteroaryl group are optionally substituted by one or two radicals R¹⁰.

26. Compounds according to claim 22, wherein R¹ and R², identically or differently on each occurrence, are H, CN, a straight-chain alkyl group having up to 20 C atoms or a branched alkyl group having 3 to 20 C atoms, wherein one or more non-adjacent CH₂ groups of said straight-chain alkyl group and branched alkyl group is optionally replaced by —R²⁰C═CR²⁰—, —C≡C—, —O— or —S—, and wherein one or more H atoms are optionally replaced by F, an aryl group having 6 to 16 C atoms or a heteroaryl group having 2 to 16 C atoms, wherein said aryl group and heteroaryl group are optionally substituted by one or more radicals R¹⁰, and/or wherein R¹ and R², independently of one another, optionally define a cyclic system together with Ar¹ and/or Ar².

27. Compounds according to claim 22, wherein R¹ and R² are H, CN, methyl, ethyl, propyl, i-propyl, n-butyl, sec-butyl, tert-butyl, or a phenyl or heteroaryl group having 4 to 6 C atoms, which is optionally substituted by one or more radicals R¹⁰, and/or wherein R¹ and R², independently of one another, optionally define a cyclic system together with Ar¹ and/or Ar².

28. Compounds according to claim 22, wherein R¹⁰, identically or differently on each occurrence, is H, F, CN, a straight-chain alkyl or alkoxy group having up to 20 C atoms, a branched alkyl or alkoxy group having 3 to 20 C atoms, a cyclic alkyl or alkoxy group having 5 to 20 C atoms, wherein said straight-chain alkyl or alkoxy group, branched alkyl or alkoxy group, and cyclic alkyl or alkoxy group are optionally substituted by one or more radicals R²⁰, and wherein one or more non-adjacent CH₂ groups of said straight-chain alkyl or alkoxy group, branched alkyl or alkoxy group, and cyclic alkyl or alkoxy group is optionally replaced by —R²⁰C═CR²⁰—, —C≡C—, Si(R²⁰)₂, C═O, —O— or —S—, and wherein one or more H atoms is optionally replaced by F, an aryl group having 6 to 16 C atoms, a heteroaryl group having 2 to 16 C atoms, an aryloxy or heteroaryloxy group having 2 to 16 aromatic C atoms, wherein said aryl group, heteroaryl group, aryloxy group and heteroaryloxy group are optionally substituted by one or more radicals R²⁰, or a combination of two, three, four or five of these systems; and wherein two or more substituents R¹⁰, on the same ring and/or on different rings, optionally define a monocyclic or polycyclic aliphatic ring system or a monocyclic or polycyclic aromatic ring system with one another or together with R¹ and/or R².

29. Compounds according to claim 22, wherein Ar¹ and Ar², identically or differently on each occurrence, is a phenyl or heteroaryl group having 4 to 6 C atoms; wherein R¹ and R², identically or differently on each occurrence, is H, a straight-chain alkyl group having up to 10 C atoms or a branched alkyl group having 3 to 4 C atoms, wherein one or more non-adjacent CH₂ groups of said straight-chain alkyl group and branched alkyl group are optionally replaced by —O— or —S— and wherein one or more H atoms is optionally replaced by F; wherein R¹⁰, on each occurrence, identically or differently, is H, F, Br, I, CN, or a straight-chain alkyl group having up to 10 C atoms, wherein one or more non-adjacent CH₂ groups, independently of one another, are optionally replaced by —O— or —S—, and wherein one or more H atoms are optionally replaced by F, Cl, Br, I, CN, NO₂, an aryl group having 6 to 14 C atoms, a heteroaryl group having 2 to 10 C atoms, an aryloxy group having 6 to 10 aromatic C atoms, or a heteroaryloxy group having 2 to 10 aromatic C atoms, wherein said aryl group, heteroaryl group, aryloxy group, and heteroaryloxy group are optionally substituted by one or more radicals R²⁰.

30. Compounds according to claim 22, wherein the sum of n and m is at least 1.

31. Compounds according to claim 22, wherein n, identically or differently on each occurrence, is 1, 2 or 3.

32. Compounds according to claim 22, wherein m, identically or differently on each occurrence, is 1, 2 or 3.

33. Compounds according to claim 22, wherein q, identically or differently on each occurrence, is 1, 2 or 3.

34. Mixtures comprising at least one compound of the formula (1) 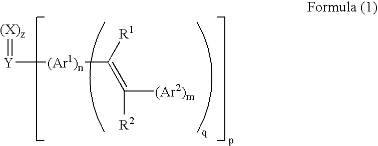
wherein
Y is on each occurrence P, As, Sb, Bi, O, S, Se, or Te, and wherein when Y═O, X is a free electron pair, and wherein when Y═S, Se or Te, X, identically or differently on each occurrence, is a free electron pair or O;
X is on each occurrence, identically or differently, O, S, Se, Te, or a free electron pair;
Ar¹ and Ar²
are on each occurrence, identically or differently, an aryl group having 6 to 24 C atoms or a heteroaryl group having 2 to 24 C atoms, wherein said aryl group and heteroaryl group is optionally substituted by one or more radicals R¹⁰;
R¹ and R²
are on each occurrence, identically or differently, H, CN, F, a straight-chain alkyl group having up to 40 C atoms, a branched alkyl group having 3 to 40 C atoms, or a cyclic alkyl group having 3 to 40 C atoms, wherein said straight-chain, branched, and cyclic alkyl groups are optionally substituted by one or more radicals R²⁰, and wherein one or more non-adjacent CH₂ groups in said straight-chain, branched, and cyclic alkyl groups are, independently of one another, optionally replaced by —R²⁰C═CR²⁰—, —C≡C—, Si(R²⁰)₂, Ge(R²⁰)₂, Sn(R²⁰)₂, C═O, C═S, C═Se, C═NR²⁰, —O—, —S—, —COOR²⁰— or —CONR²⁰—, and wherein one or more H atoms are optionally replaced by F, Cl, Br, I, CN, SCN, NO₂, an aromatic system having 6 to 40 aromatic C atoms, a heteroaromatic system having 2 to 40 aromatic C atoms, an aryloxy group having 6 to 40 aromatic C atoms or a heteroaryloxy group having 2 to 40 aromatic C atoms, wherein said aromatic system, heteroaromatic system, aryloxy group and heteroaryloxy group are optionally substituted by one or more radicals R¹⁰, and wherein R¹ and R², independently of one another, optionally define a cyclic system together with Ar¹ and/or Ar²;
R¹⁰ is on each occurrence, identically or differently, H, F, Cl, Br, I, CN, NO₂, a straight-chain alkyl group having up to 40 C atoms, a branched alkyl group having 3 to 40 C atoms, or a cyclic alkyl group having 3 to 40 C atoms, wherein said straight-chain, branched, and cyclic alkyl groups are optionally substituted by one or more radicals R²⁰, and wherein one or more non-adjacent CH₂ groups in said straight-chain, branched, and cyclic alkyl groups are, independently of one another, optionally replaced by —R²⁰C═CR²⁰—, —C≡C—, Si(R²⁰)₂, Ge(R²⁰)₂, Sn(R²⁰)₂, C═O, C═S, C═Se, C═NR²⁰, —O—, —S—, —COOR²⁰— or —CONR²⁰— and wherein one or more H atoms are optionally replaced by F, Cl, Br, I, CN, NO₂, an aryl group having 6 to 24 C atoms, a heteroaryl group having 2 to 24 C atoms, an aryloxy group having 6 to 24 aromatic C atoms, a heteroaryloxy group having 2 to 24 aromatic C atoms, wherein said aromatic system, heteroaromatic system, aryloxy group and heteroaryloxy group are optionally substituted by one or more radicals R²⁰, or a combination of two, three, four or five of these systems; and wherein two or more substituents R¹⁰, on the same ring and/or on different rings, optionally define a monocyclic or polycyclic aliphatic ring system or a monocyclic or polycyclic aromatic ring system with one another or together with R¹ and/or R²;
R²⁰ is on each occurrence, identically or differently, H or an aliphatic or aromatic hydrocarbon radical having up to 20 C atoms;
n is, identically or differently on each occurrence, 0, 1, 2, 3, 4 or 5;
m is, identically or differently on each occurrence, 0, 1, 2, 3, 4 or 5;
q is, identically or differently on each occurrence, 0, 1, 2, 3, 4 or 5, with the proviso that at least one q is does not equal 0;
p is 2 when Y is an element from main group 6 of the Periodic Table and is 3 when Y is an element from main group 5 of the Periodic Table;
z is 1 when Y is an element from main group 5 of the Periodic Table and is 2 when Y is an element from main group 6 of the Periodic Table; and
at least one host material.

35. Mixtures according to claim 34, wherein said at least one host material is selected from the group consisting of oligoarylenes, oligoarylenevinylenes, polypodal metal complexes, ketones, phosphine oxides, sulfoxides, and atropisomers thereof.

36. Mixtures according to claim 34, wherein the proportion of said at least one compound of the formula (1) in the mixture is between 0.1 and 99.0% by weight.

37. Mixtures according to claim 34, wherein the proportion of said at least one host material in the mixture is between 1.0 and 99.9% by weight.

38. Conjugated, partially conjugated or non-conjugated polymers, oligomers or dendrimers comprising recurring units of compounds according to claim 22.

39. An electronic device comprising compounds according to claim 22.

40. An organic electronic device comprising compounds according to claim 22.

41. An electronic device according to claim 40, wherein said electronic device is selected from the group consisting of organic light-emitting diodes, organic field-effect transistors, organic light-emitting transistors, organic thin-film transistors, organic integrated circuits, organic solar cells, organic field-quench devices, or organic laser diodes.

42. An electronic device comprising at least one compound according to claim 22 and/or at least one mixture of said at least one compound with at least one host material and/or at least one conjugated, partially conjugated or non-conjugated polymer, oligomer or dendrimer comprising recurring units of said at least one compound.

43. An electronic device according to claim 42, wherein said electronic device is selected from the group consisting of organic light-emitting diodes, organic field-effect transistors, organic light-emitting transistors, organic thin-film transistors, organic integrated circuits, organic solar cells, organic field-quench devices and organic laser diodes.
